(19) United States
(12) Patent Application Publication
(10) Pub. No.: US 2012/0274542 A1
(43) Pub. Date: Nov. 1, 2012

(54) DISPLAY DEVICE

(75) Inventors: Shunpei YAMAZAKI, Setagaya (JP); Yoshiharu HIRAKATA, Ebina (JP); Masaaki HIROKI, Isehara (JP); Jun KOYAMA, Sagamihara (JP)

(73) Assignee: SEMICONDUCTOR ENERGY LABORATORY CO., LTD., Atsugi-shi (JP)

(21) Appl. No.: 13/450,758

(22) Filed: Apr. 19, 2012

(30) Foreign Application Priority Data
Apr. 26, 2011 (JP) 2011-097819

(51) Int. Cl. G09G 3/00

(52) U.S. Cl. 345/32

(57) ABSTRACT

An object is to provide a display device on which 3D images can be perceived from a large area. A parallax barrier panel includes a first substrate provided with a plurality of light-blocking layers and a plurality of light-transmitting layers, and a second substrate. The light-blocking layers and the light-transmitting layers are alternately provided in contact with one surface of the first substrate and are interposed between the first substrate and the second substrate. The refraction index of each of the light-transmitting layers is different from the refraction index of the first substrate or the refraction index of the second substrate. The parallax barrier panel is stacked with a display panel including a plurality of pairs of a pixel for the right eye and a pixel for the left eye.

### BACKGROUND OF THE INVENTION

1. Field of the Invention

The present invention relates to display devices. In particular, the present invention relates to a display device capable of displaying three-dimensional (3D) images.

2. Description of the Related Art

A variety of display devices ranging from large display devices such as television devices to small display devices such as mobile phones are put on the market. High value-added products will be needed and are being developed. In recent years, display devices capable of displaying 3D images have been developed in order to display more realistic images.

As methods of displaying 3D images, there are a method using glasses for separating an image seen with a left eye and an image seen with a right eye (also referred to as stereoscopy), and autostreoscopy by which 3D images can be seen with the naked eye by addition of a structure for separating an image seen with a left eye and an image seen with a right eye in a display portion. It is not necessary to prepare glasses to see autostreoscopic 3D images, which offers high convenience. Autostreoscopic 3D display is coming into widespread use for mobile phones, portable game consoles, and the like.

As a method of displaying autostreoscopic 3D images, there is known a parallax barrier method in which a parallax bather is added to a display portion. A parallax barrier for this method is a stripe-shaped light-blocking portion and causes a decrease in resolution when display is switched from 3D display to two-dimensional (2D) display. In view of this, for a parallax barrier method, there is suggested a structure in which a liquid crystal panel having a patterned transparent electrode is used, and when display is switched between 2D display and 3D display, transmission or blocking of light by a liquid crystal layer is controlled by controlling voltage applied to the transparent electrode in order to set the presence or absence of a parallax barrier (see Patent Document 1).

### REFERENCE

### Patent Document

### [Patent Document 1] Japanese Published Patent Application No. 2005-258013

### SUMMARY OF THE INVENTION

Meanwhile, in order to display 3D images by a parallax barrier method, a specific distance is required between a display screen and the eyes of the viewer.

One embodiment of the present invention is made in view of the foregoing technical background. An object of one embodiment of the present invention is to provide a display device on which 3D images can be perceived from a large area.

In order to achieve the above object, a focus of one embodiment of the present invention is put on the structure of a display panel and a parallax barrier panel provided thereover.

That is, one embodiment of the present invention is a display device which includes a display panel including a plurality of pairs of a pixel for a right eye and a pixel for a left eye, and a parallax barrier panel including a plurality of light-blocking parallax barriers and light-transmitting regions between the parallax barriers. Further, the parallax barriers each include a light-blocking layer interposed between one surface of a first substrate and a second substrate, and the light-transmitting regions each include a light-transmitting layer interposed between the one surface of the first substrate and the second substrate. Further, the other surface of the first substrate in the parallax barrier panel faces a display surface of the display panel, the parallax barriers are provided above and away from the pairs of the pixel for the right eye and the pixel for the left eye by a distance greater than or equal to the thickness of the first substrate and less than or equal to 0.7 mm, and the refraction index of the light-transmitting layer is different from the refraction index of the first substrate or the refraction index of the second substrate.

In the display device according to one embodiment of the present invention, the substrates and the light-transmitting layer which are included in the parallax barrier panel have different refraction indices. Thus, the area from which the pixel for the right eye can be seen with the right eye and the area from which the pixel for the left eye can be seen with the left eye are expanded. As a result, a display device on which 3D images can be perceived from a large area can be provided.

One embodiment of the present invention is a display device which includes a display panel including a plurality of light-emitting elements, and a parallax barrier panel including a plurality of light-blocking parallax barriers and light-transmitting regions between the parallax barriers. The plurality of light-emitting elements includes a plurality of reflective electrodes over an element substrate, a semi-transmissive and semi-reflective electrode overlapping with the plurality of reflective electrodes, and a layer containing a light-emitting organic compound between the plurality of reflective electrodes and the semi-transmissive and semi-reflective electrode. Further, the parallax barriers each include a light-blocking layer interposed between one surface of a first substrate and a second substrate, and the light-transmitting regions each include a light-transmitting layer interposed between the one surface of the first substrate and the second substrate. Further, the plurality of light-emitting elements is sealed between the element substrate and the other surface of the first substrate in the parallax barrier panel, with a sealant surrounding the plurality of light-emitting elements. Furthermore, the parallax barriers are each provided above and away from a pair of a pixel for a right eye and a pixel for a left eye by a distance greater than or equal to the thickness of the first substrate and less than or equal to 0.7 mm, and the refraction index of the light-transmitting layer is different from the refraction index of the first substrate or the refraction index of the second substrate.

The display device according to one embodiment of the present invention includes the light-emitting elements in which the layer containing a light-emitting organic compound is interposed between the reflective electrodes and the semi-transmissive and semi-reflective electrode. Further, the substrates and the light-transmitting layer which are included in the parallax barrier panel have different refraction indices. Thus, light from the light-emitting elements, which is condensed by a microcavity formed between the reflective electrodes and the semi-transmissive and semi-reflective electrode, is expanded by the light-transmitting layer having a different refraction index. Accordingly, the area from which the pixel for the right eye can be seen with the right eye and the area from which the pixel for the left eye can be seen with the left eye are expanded. As a result, a display device on which 3D images can be perceived from a large area can be provided.

One embodiment of the present invention is the display device in which the refraction index of the first substrate and the refraction index of the second substrate are each higher than or equal to 1.3 and lower than or equal to 1.6, and the refraction index of the light-transmitting layer is higher than or equal to 1.0 and lower than or equal to 1.1.

In the display device according to one embodiment of the present invention, the substrates and the light-transmitting layer which are included in the parallax barrier panel have different refraction indices. Thus, the area from which the pixel for the right eye can be seen with the right eye and the area from which the pixel for the left eye can be seen with the left eye are expanded. As a result, a display device on which 3D images can be perceived from a large area can be provided.

One embodiment of the present invention is the display device in which the width of the light-transmitting layer is greater than or equal to 32 μm and less than or equal to 72 μm.

One embodiment of the present invention is the display device in which the distance from the center of the pixel for the right eye to the center of the pixel for the left eye is greater than or equal to 36.3 μm and less than or equal to 72.6 μm (the resolution is higher than or equal to 350 ppi and lower than or equal to 700 ppi).

In the display device according to one embodiment of the present invention, the substrates and the light-transmitting layer which are included in the parallax barrier panel have different refraction indices. Thus, the area from which the pixel for the right eye can be seen with the right eye and the area from which the pixel for the left eye can be seen with the left eye are expanded. As a result, a display device on which 3D images can be perceived from a large area can be provided.

One embodiment of the present invention is the display device in which the thickness of the first substrate is greater than or equal to 0.1 mm and less than or equal to 0.5 mm.

In the display device according to one embodiment of the present invention, the substrates and the light-transmitting layer which are included in the parallax barrier panel have different refraction indices. Therefore, a user can view particularly favorable 3D images in the state of holding the display device with his or her own hands.

One embodiment of the present invention is the display device in which the other surface of the first substrate is provided with a color filter.

Multicolor 3D images can be perceived on the display device according to one embodiment of the present invention.

In the above display device, each of the plurality of pixels in the display panel includes a light-emitting element in which a layer containing a light-emitting organic compound is provided between a pair of electrodes.

In the display device according to one embodiment of the present invention, the aperture ratio of a pixel provided in a pixel portion is less likely to be affected by a wiring or a transistor and thus can be increased. Moreover, there is no need to use a polarizing plate. Consequently, power consumption can be reduced.

Note that in this specification, an “EL layer” refers to a layer provided between a pair of electrodes in a light-emitting element. Thus, a light-emitting layer containing an organic compound that is a light-emitting substance, which is interposed between electrodes, is one embodiment of an EL layer.

In this specification, a reflective film has a reflectivity higher than or equal to 1%, preferably higher than or equal to 30% and lower than 100%, in a range of wavelengths greater than or equal to 400 nm and less than 800 nm; a semi-transmissive and semi-reflective film has a reflectivity higher than or equal to 1%, preferably higher than or equal to 5% and lower than 100%, and a light transmittance higher than or equal to 1%, preferably higher than or equal to 30% and lower than 100%, in a range of wavelengths greater than or equal to 400 nm and less than 800 nm.

In this specification, in the case where a substance A is dispersed in a matrix formed using a substance B, the substance B forming the matrix is referred to as host material, and the substance A dispersed in the matrix is referred to as guest material. Note that the substance A and the substance B may each be a single substance or a mixture of two or more kinds of substances.

Note that a light-emitting device in this specification means an image display device, a light-emitting device, or a light source (including a lighting device). In addition, the light-emitting device includes the following modules in its category: a module in which a connector such as a flexible printed circuit (FPC), a tape automated bonding (TAB) tape, or a tape carrier package (TCP) is attached to a light-emitting device; a module in which a printed wiring board is provided at the end of a TAB tape or a TCP; and a module in which an integrated circuit (IC) is directly mounted on a substrate provided with a light-emitting element by a chip on glass (COG) method.

According to one embodiment of the present invention, a display device on which 3D images can be perceived from a large area can be provided.

### BRIEF DESCRIPTION OF THE DRAWINGS

In the accompanying drawings:

FIGS. 1A and 1B illustrate a structure of a display device according to an embodiment;

FIG. 2 illustrates operation of a display device according to an embodiment;

FIGS. 3A and 3B illustrate a display device according to an embodiment;

FIGS. 4A to 4C illustrate pixels of a display device according to an embodiment;

FIGS. 5A to 5C each illustrate a structure of a light-emitting element according to an embodiment;

FIGS. 6A and 6B each illustrate a structure of a light-emitting element according to an embodiment; and

FIGS. 7A to 7C each illustrate an electronic appliance according to an embodiment.

### DETAILED DESCRIPTION OF THE INVENTION

Embodiments will be described in detail with reference to the drawings. Note that the present invention is not limited to the following description, and it will be easily understood by those skilled in the art that various changes and modifications can be made without departing from the spirit and scope of the present invention. Therefore, the present invention should not be construed as being limited to the description in the following embodiments. Note that in the structures of the invention described below, the same portions or portions having similar functions are denoted by the same reference numerals in different drawings, and description of such portions is not repeated.

### Embodiment 1

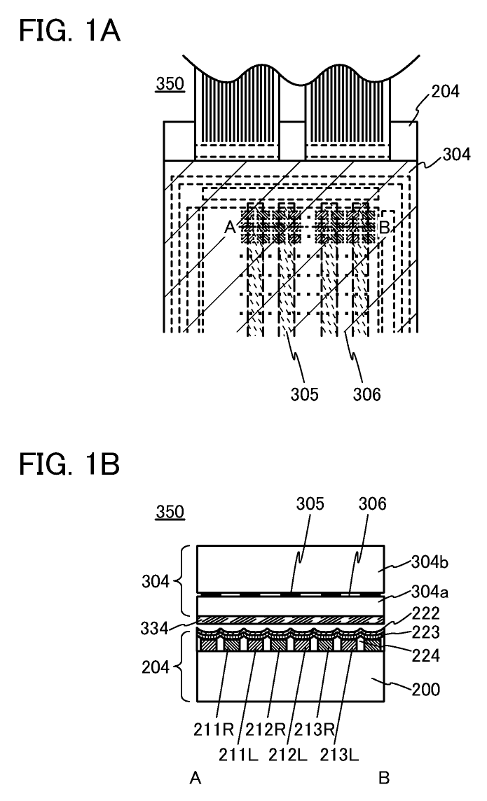

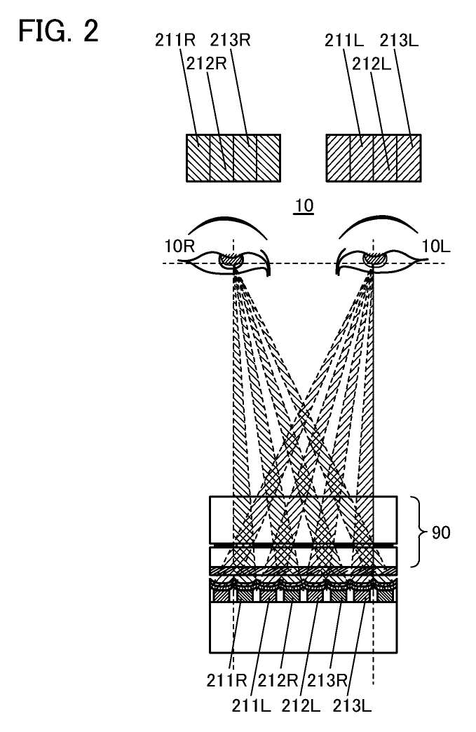

In this embodiment, a structure of a display panel and a parallax barrier panel in a display device capable of displaying 3D images according to one embodiment of the present invention will be described with reference to FIGS. 1A and 1B. In addition, operation of the display device will be described with reference to FIG. 2.

FIGS. 1A and 1B illustrate a structure of the display device according to one embodiment of the present invention. FIG. 1A is a top view of the display device according to one embodiment of the present invention, and FIG. 1B is a cross-sectional view taken along line A-B in FIG. 1A. A display device 350 illustrated in FIG. 1A includes a display panel 204 and a parallax barrier panel 304.

### <Structure 1 of Display Panel>

The display panel 204 includes a plurality of pixels (e.g., 211R, 211L, 212R, 212L, 213R, and 213L). These pixels are formed over a substrate 200 and provided with reflective electrodes which are separated by a partition wall 224. Over the reflective electrodes, a layer 223 containing a light-emitting organic compound and a semi-transmissive and semi-reflective electrode 222 which covers the layer 223 containing a light-emitting organic compound are provided. Although not illustrated in the drawings in this embodiment, switching elements are connected to the respective reflective electrodes over the substrate, whereby light-emitting elements in the display panel 204 can be independently driven and an image can be displayed.

When 3D images are displayed using the display panel 204, the pixels in the display panel 204 are divided into pixels for the right eye and pixels for the left eye so that adjacent two pixels are paired. Examples of the pair of pixels are (211R and 211L), (212R and 212L), and (213R and 213L). Then, display may be performed on the pixels for the right eye in accordance with image signals for the right eye, and display may be performed on the pixels for the left eye in accordance with image signals for the left eye. In the case of displaying 2D images, display may be performed on the pixels for the right eye and the pixels for the left eye in accordance with the same image signals.

### <Structure 2 of Display Panel>

Note that FIG. 1B illustrates a structure in which each of the pixels in the display panel includes a light-emitting element containing a light-emitting organic compound; it is also possible to use a liquid crystal display element for each of the pixels in the display panel. In the case of using a liquid crystal display element, the following structure may be employed: a first polarizing plate and a backlight are provided on a side of the display panel which is opposite to a side facing the parallax barriers, and a second polarizing plate is provided on the side of the display panel which faces the parallax barriers.

### <Structure of Parallax Barrier Panel>

The parallax barrier panel 304 includes light-transmitting regions and light-blocking regions functioning as a parallax barrier. The light-transmitting regions and the light-blocking regions are formed using light-transmitting layers 306 and light-blocking layers 305, respectively, which are provided between a first substrate 304a and a second substrate 304b.

The first substrate 304a and the second substrate 304b are preferably formed using a material having a light transmittance higher than or equal to 50% in a wavelength range from 400 nm to 800 nm. Typically, besides a glass substrate, a substrate or a film made of a flexible synthetic resin such as plastic can be used as long as it can withstand a processing temperature in the manufacturing process.

In terms of availability, a material having a refraction index higher than or equal to 1.2 and lower than or equal to 1.6 is preferably used for each of the first substrate 304a and the second substrate 304b.

When the thickness of the first substrate 304a is greater than or equal to 0.1 mm and less than or equal to 0.5 mm, a user can view particularly favorable 3D images in the state of holding the display device with his or her own hands.

In the case where the first substrate 304a also serves as a sealing substrate for the light-emitting elements, a material having a property of preventing diffusion of an impurity contained in the air into the light-emitting elements is used for the first substrate 304a. Specifically, when a material having a gas barrier property such that the vapor permeability is lower than or equal to 10⁻⁵ g/m²·day, preferably lower than or equal to 10⁻⁶ g/m²·day, is used, the reliability of the light-emitting elements can be improved.

The light-blocking layer 305 has a light-blocking property and can be formed using, for example, a conductive layer containing chromium, an organic material containing a pigment or black carbon, or a material obtained by dyeing an organic material such as acrylic or polyimide.

Further, the light-blocking layer 305 provided between the first substrate 304a and the second substrate 304b can also function to adjust the gap therebetween. The typical thickness of the light-blocking layer 305 is approximately 1.0 μm to 1.5 μm.

The light-transmitting layer 306 has a light-transmitting property that allows display on the display panel to be viewed through the light-transmitting layer 306, and preferably transmits 50% or more of light with wavelengths ranging from 400 nm to 800 nm, for example.

The refraction index of the light-transmitting layer 306 is different from the refraction index of the first substrate or the refraction index of the second substrate. Specifically, when the refraction indices of the first substrate and the second substrate are each higher than or equal to 1.2 and lower than or equal to 1.6, the refraction index of the light-transmitting layer 306 is preferably higher than or equal to 1.0 and lower than or equal to 1.1. Thus, the area from which the pixel for the right eye can be seen with the right eye and the area from which the pixel for the left eye can be seen with the left eye are expanded. As a result, a display device on which 3D images can be perceived from a large area can be provided.

When the width of the light-transmitting layer is set to be greater than or equal to 32 μm and less than or equal to 72 μm or when the distance from the pixel for the right eye to the pixel for the left eye is set to be greater than or equal to 36.3 μm and less than or equal to 72.6 μm (the resolution is set to be higher than or equal to 350 ppi and lower than or equal to 700 ppi), an effect of a pinhole or diffraction grating is obtained with the light-transmitting layer having a small width. Thus, a display device on which 3D images can be perceived from a large area can be provided.

Further, the other surface of the first substrate 304a in this embodiment is provided with a color filter 334. With such a structure, the parallax barrier panel 304 also serves as a color filter and thus the number of components is reduced, leading to resource saving and cost reduction.

3D display performed using the display device in this embodiment will be described with reference to FIG. 2. The pixels in the display panel 204 are divided into pixels for the right eye and pixels for the left eye so as to form the pairs of (211R and 211L), (212R and 212L), and (213R and 213L). Above each of the pairs of pixels, a light-blocking layer is provided in a parallax barrier panel 90. A parallax barrier is disposed so as to conceal one of the pair of the pixel for the right eye and the pixel for the left eye; thus, a right eye 10R of a viewer 10 can see only the pixel for the right eye and a left eye 10L of the viewer 10 can see only the pixel for the left eye. Note that images perceived by the left and right eyes are schematically illustrated over the respective eyes of the viewer.

The display device according to one embodiment of the present invention includes the display panel including the plurality of pairs of the pixel for the right eye and the pixel for the left eye, and the parallax barrier panel including the plurality of light-blocking parallax barriers and the light-transmitting regions between the parallax barriers. Further, the parallax barriers include the light-blocking layer interposed between one surface of the first substrate and the second substrate, and the light-transmitting regions includes the light-transmitting layer interposed between the one surface of the first substrate and the second substrate. Further, the other surface of the first substrate in the parallax barrier panel faces a display surface of the display panel, the parallax barriers are provided above and away from the pairs of the pixel for the right eye and the pixel for the left eye by a distance greater than or equal to the thickness of the first substrate and less than or equal to 0.7 mm, and the refraction index of the light-transmitting layer is different from the refraction index of the first substrate or the refraction index of the second substrate.

Thus, the area from which the pixel for the right eye can be seen with the right eye and the area from which the pixel for the left eye can be seen with the left eye are expanded. As a result, a display device on which 3D images can be perceived from a large area can be provided.

This embodiment can be combined with any of the other embodiments in this specification, as appropriate.

### Embodiment 2

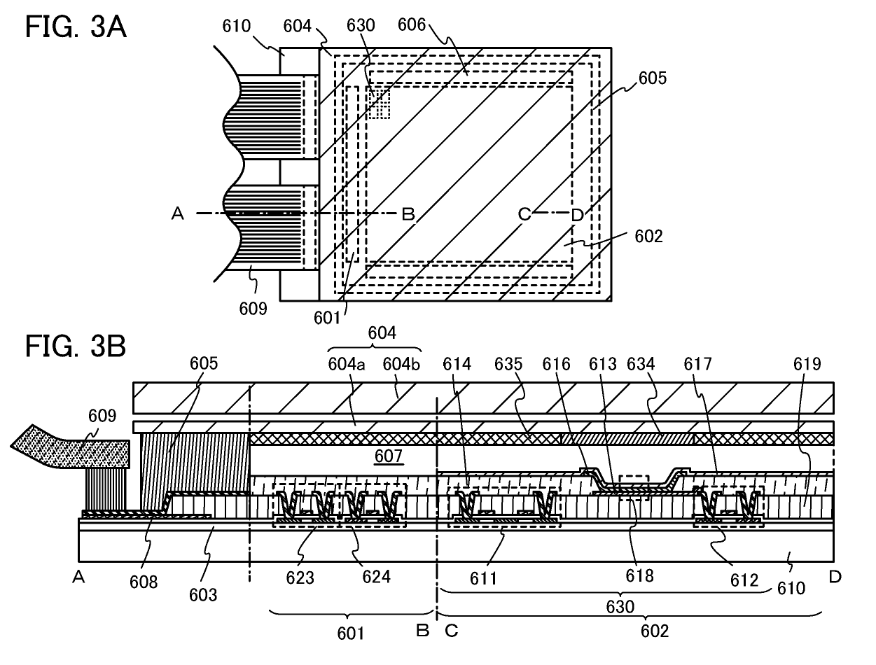

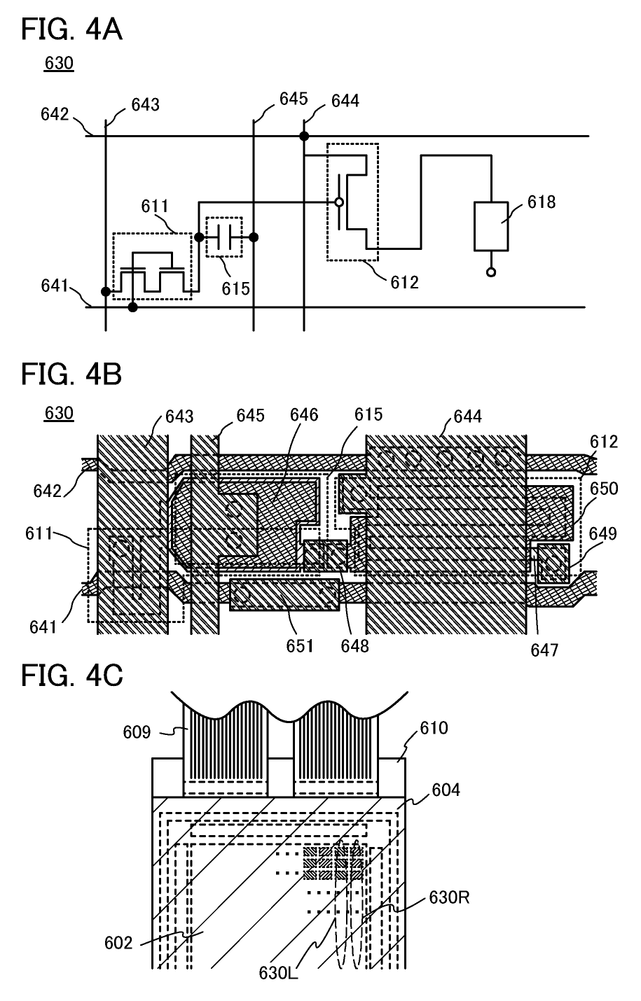

In this embodiment, one embodiment of a display panel which can be applied to a display device capable of displaying 3D images according to one embodiment of the present invention will be described with reference to FIGS. 3A and 3B and FIGS. 4A to 4C. Specifically, an active matrix display device including a light-emitting element (also referred to as light-emitting display element) will be described. Note that the light-emitting element includes, in its category, an element whose luminance is controlled by current or voltage, and specifically includes an EL element.

FIGS. 3A and 3B illustrate a structure of the display device according to one embodiment of the present invention. FIG. 3A is a plan view of the display device, and FIG. 3B is a cross-sectional view taken along line A-B and line C-D in FIG. 3A.

In the display device illustrated in FIG. 3A, an element substrate 610 and a sealing substrate 604 are attached to each other with a sealant 605. Further, a driver circuit portion (a source side driver circuit 601 and a gate side driver circuit 606) and a pixel portion 602 including a plurality of pixels 630 are provided over the element substrate 610.

The source side driver circuit 601 and the gate side driver circuit 606 are connected to a wiring 608 illustrated in FIG. 3B and supplied with a video signal, a clock signal, a start signal, a reset signal, and the like through a flexible printed circuit (FPC) 609 serving as an external input terminal.

Although only the FPC is illustrated here, a printed wiring board (PWB) may be attached to the FPC. The display device in this specification includes not only a display device itself but also a display device to which an FPC or a PWB is attached.

<Structure of Pixel>

FIG. 4A illustrates an equivalent circuit of the pixel 630 included in the pixel portion 602, FIG. 4B illustrates a plan view of the pixel 630, and FIG. 4C illustrates the arrangement of the pixels 630 in the pixel portion 602.

The pixel portion 602 described in this embodiment includes the plurality of pixels 630 which are each long in the lateral direction relative to the longitudinal direction (see FIG. 4C). A pixel for the right eye and a pixel for the left eye are arranged to form a pair in the lateral direction. Further, a plurality of pixels for the right eye is arranged in the longitudinal direction to form a column 630R, and a plurality of pixels for the left eye is arranged in the longitudinal direction to form a column 630L. The pairs of the pixel for the right eye and the pixel for the left eye are arranged in a matrix in the pixel portion 602.

In each of the column 630R including the pixels for the right eye and the column 630L including the pixels for the left eye, pixels exhibiting different colors are sequentially arranged in the longitudinal direction. For example, full color display can be achieved by sequentially arranging a pixel exhibiting red (R), a pixel exhibiting green (G), and a pixel exhibiting blue (B) in the longitudinal direction.

Although not illustrated, a parallax barrier is provided to cover a region between the column 630R including the pixels for the right eye and the column 630L including the pixels for the left eye. Each of the pixels exhibiting different colors is long in the lateral direction, and the parallax barrier is provided so that left and right ends thereof cross the pixels in the longitudinal direction. Owing to such an arrangement, the area of a pixel which can be perceived by the viewer is changed when the viewing position of the viewer is laterally shifted. However, such an arrangement can prevent a phenomenon in which another pixel exhibiting a different color is seen behind the parallax barrier and a phenomenon in which a specific pixel exhibiting a color that has been perceived is concealed behind the parallax barrier to become invisible. As compared with the phenomenon in which the area of a pixel which can be perceived is changed, the phenomenon in which a different color is seen or the phenomenon in which a color is concealed is easily sensed by the viewer and thus causes a feeling of strangeness in the change of display. Accordingly, the structure described in this embodiment has an effect of expanding the area where the viewer can perceive 3D images without a feeling of strangeness.

The pixel 630 includes a transistor 611, a transistor 612, a light-emitting element 618, and a capacitor 615.

One electrode of the capacitor 615 is electrically connected to a source electrode or a drain electrode of the transistor 611, and the other electrode of the capacitor 615 is connected to a capacitor wiring 645.

In this embodiment, a scan line 641, a capacitor wiring 642, and a conductive layer 650 are formed in the same step, while a signal line 643, a current supply line 644, a conductive layer 648, and a conductive layer 649 are formed in the same step.

An increase in definition leads to a decrease in the distance between pixels, which results in limitation of the width of a wiring. Consequently, the resistance of the wiring is increased in some cases. In this embodiment, an auxiliary wiring 651 is provided in a layer overlapping with the scan line 641 and connected thereto through openings. With such a structure, even when the distance between pixels is reduced, an increase in the wiring resistance of the scan line 641 can be suppressed. Thus, a high-definition display device which operates stably can be provided. Note that the pixel portion of the display device described in this embodiment can have, for example, a structure in which pixels each including subpixels of R, G, and B are provided at a resolution of 457.8 ppi so as to be arranged in a matrix of 1440 horizontal pixels by 1080 vertical pixels. In addition, the subpixel in this structure may have a size of 18.5 μm long and 55.5 μm wide.

### <Structure of Transistor>

A gate electrode of the transistor 611 is electrically connected to the scan line 641. One of the source electrode and the drain electrode of the transistor 611 is electrically connected to the signal line 643. A channel formation region of the transistor 611 is formed using a single crystal semiconductor. The transistor 611 functions as a switching transistor and includes the scan line 641 serving as the gate electrode, a semiconductor layer 646 including the channel formation region formed using a single crystal semiconductor, and the signal line 643 functioning as the source electrode or the drain electrode.

A gate electrode of the transistor 612 is electrically connected to the other of the source electrode and the drain electrode of the transistor 611. One of a source electrode and a drain electrode of the transistor 612 is electrically connected to the current supply line 644. A channel formation region of the transistor 612 is formed using a single crystal semiconductor. The transistor 612 functions as a current-controlling transistor and includes the conductive layer 650 functioning as the gate electrode, a semiconductor layer 647 including the channel formation region formed using a single crystal semiconductor, and the conductive layer 649 functioning as the source electrode or the drain electrode.

Note that in the pixel 630 described in this embodiment, the transistor 611 is an n-channel transistor and the transistor 612 is a p-channel transistor.

The transistor 611 and the transistor 612 are electrically connected to each other by the conductive layer 648 in contact with the semiconductor layer 646 and the conductive layer 650. The conductive layer 648 functions as the source electrode or the drain electrode of the transistor 611.

The channel formation regions in the semiconductor layers 646 and 647 are formed using a single crystal semiconductor. When the channel formation regions are formed using a single crystal semiconductor, a reduction in transistor size can be achieved, leading to higher-definition pixels in the display portion.

Typical examples of a single crystal semiconductor substrate for the semiconductor layers 646 and 647 include single crystal semiconductor substrates including elements that belong to Group 14, such as a single crystal silicon substrate, a single crystal germanium substrate, and a single crystal silicon germanium substrate; and compound semiconductor substrates (such as an SiC substrate, a sapphire substrate, and a GaN substrate). Preferred one is a silicon on insulator (SOI) substrate in which a single crystal semiconductor layer is provided on an insulating surface.

As a method of forming the SOI substrate, any of the following methods can be used: a method in which oxygen ions are implanted into a mirror-polished wafer and then heating is performed at a high temperature, whereby an oxide layer is formed at a certain depth from a surface of the wafer and a defect caused in the surface layer is eliminated; a method in which a semiconductor substrate is separated by utilizing a phenomenon in which microvoids formed by hydrogen ion irradiation grow due to heat treatment; a method in which a single crystal semiconductor layer is formed on an insulating surface by crystal growth; and the like.

In this embodiment, ions are added through one surface of a single crystal semiconductor substrate, an embrittlement layer is formed at a certain depth from the surface of the single crystal semiconductor substrate, and an insulating layer 603 is formed over one of the surface of the single crystal semiconductor substrate and the element substrate 610. Heat treatment is performed in a state where the single crystal semiconductor substrate and the element substrate 610 are bonded to each other with the insulating layer 603 interposed therebetween, so that a crack is generated in the embrittlement layer and the single crystal semiconductor substrate is separated along the embrittlement layer. Accordingly, a single crystal semiconductor layer, which is separated from the single crystal semiconductor substrate, is formed as the semiconductor layers 646 and 647 over the element substrate 610.

An isolation region may be formed in the semiconductor substrate to form the transistors 611 and 612 by using isolated semiconductor regions.

The use of the single crystal semiconductor as a channel formation region can reduce variation in the electric characteristics of a transistor, such as threshold voltage, due to a bonding defect at a crystal grain boundary. Hence, in the display device according to one embodiment of the present invention, the light-emitting element can operate normally without providing a circuit for compensating threshold voltage in each pixel. The number of circuit elements per pixel can therefore be reduced, increasing the flexibility in layout. Thus, a high-definition display device can be achieved. For example, a display device including a matrix of a plurality of pixels, specifically 350 pixels or more per inch (i.e., the horizontal resolution is 350 pixels per inch (ppi) or higher), preferably 400 or more pixels per inch (i.e., the horizontal resolution is 400 ppi or higher) can be achieved.

Moreover, a transistor whose channel formation region is formed using a single crystal semiconductor can be downsized while keeping high current drive capability. The use of the downsized transistor leads to a reduction in the area of a circuit portion that does not affect display operation, resulting in an increase in the display area of the display portion and a reduction in the frame size of the display device.

### <Structure of Light-Emitting Element>

The light-emitting element 618 is a light-emitting element emitting white light. In the light-emitting element 618, an EL layer 616 containing a light-emitting organic compound is provided between a reflective electrode 613 and a semi-transmissive and semi-reflective electrode 617 having reflectivity and a light-transmitting property.

The reflective electrode 613 of the light-emitting element 618 is electrically connected to the other of the source electrode and the drain electrode of the transistor 612 through the conductive layer 649, and the semi-transmissive and semi-reflective electrode 617 is electrically connected to a common electrode which is not illustrated. The reflective electrode 613 is provided over the transistor 611, the transistor 612, and the capacitor 615.

The EL layer 616 of the light-emitting element 618 is formed, for example, by stacking a first light-emitting layer and a second light-emitting layer which emit light of different colors that are complementary colors. With such a structure, white light can be obtained from the light-emitting element 618. Alternatively, white light emission can be obtained from the light-emitting element in the following manner: the EL layer 616 is formed by stacking a first light-emitting layer, a second light-emitting layer, and a third light-emitting layer which emit red light, green light, and blue light, respectively.

A color filter layer 634 is provided in accordance with the color of the pixel so as to overlap with the light-emitting element.

The color filter layer is provided in accordance with the color of the pixel. For example, a blue (B) pixel, a green (G) pixel, and a red (R) pixel may have a blue color filter layer, a green color filter layer, and a red color filter layer, respectively.

The display device can be a multicolor display device when a pixel including subpixels emitting light of at least two colors, e.g., any of blue (B), green (G), and red (R), is provided in the pixel portion 602. Alternatively, the display device may have a display panel for single color display.

The display device can be a full-color display device when light-emitting elements capable of emitting white light in this way overlap with the red (R), green (G), and blue (B) color filter layers.

Note that the EL layer 616 can have a stacked structure including a hole-injection layer, a hole-transport layer, an electron-transport layer, an electron-injection layer, and/or the like in addition to a light-emitting layer. In addition, a plurality of EL layers may be stacked and a charge generation layer may be provided between one EL layer and another EL layer. When a plurality of light-emitting layers is stacked between an anode and a cathode, the light-emitting element can emit white light, for example.

Note that a light-transmitting conductive layer may be provided between the reflective electrode 613 and the EL layer 616. The light-transmitting conductive layer has a function of adjusting the optical distance between the reflective electrode 613 and the semi-transmissive and semi-reflective electrode 617 in each subpixel. By enhancing a desired spectrum with a microcavity in a light-emitting element provided in each subpixel, a display panel with high color purity can be achieved.

Note that an insulator 614 is formed to cover an end portion of the reflective electrode 613. Here, the insulator 614 is formed using a positive type photosensitive acrylic resin film.

The insulator 614 preferably has a curved surface with curvature at an upper edge portion or a lower edge portion thereof in order to obtain favorable coverage. For example, in the case of using positive type photosensitive acrylic for the insulator 614, only the upper edge portion of the insulator 614 preferably has a curved surface with a radius of curvature (0.2 μm to 3 μm). As the insulator 614, either a negative type material which becomes insoluble in an etchant by light irradiation or a positive type material which becomes soluble in an etchant by light irradiation can be used.

### <Light-Blocking Layer>

A light-blocking layer 635 may be provided so as to overlap with a region between the pixels or the driver circuit portion. The shape of the light-blocking layer may be a stripe shape or a lattice shape (also referred to as matrix shape), and a matrix-shaped light-blocking layer can be called black matrix.

The light-blocking layer 635 is formed using a light-blocking material that reflects or absorbs light. For example, a black organic resin can be used, which may be formed by mixing a black resin of a pigment material, carbon black, titanium black, or the like into a resin material such as photosensitive or non-photosensitive polyimide. Alternatively, a light-blocking metal film can be used, which may be formed using chromium, molybdenum, nickel, titanium, cobalt, copper, tungsten, or aluminum, for example.

There is no particular limitation on the method of forming the light-blocking layer 635, and a dry method such as an evaporation method, a sputtering method, or a CVD method or a wet method such as spin coating, dipping, spray coating, a droplet discharging method (such as an inkjet method), or a printing method (such as screen printing or offset printing) may be used depending on the material. As needed, an etching method (dry etching or wet etching) may be employed to form a desired pattern.

The light-blocking layer 635, which can prevent light from leaking to an adjacent pixel, enables higher-contrast and higher-definition display.

### <Sealing Structure>

Further, the sealing substrate 604 serving also as a parallax barrier panel is attached to the element substrate 610 with the sealant 605, so that the light-emitting element 618 is provided in a space 607 surrounded by the element substrate 610, the sealing substrate 604, and the sealant 605. The space 607 may be filled with filler such as an inert gas (e.g., nitrogen or argon), an organic resin, or the sealant 605. A material containing a hygroscopic substance may be used for the organic resin and the sealant 605. The sealing substrate 604 includes a light-transmitting region and a light-blocking region functioning as a parallax barrier. The light-transmitting region and the light-blocking region are formed using a light-transmitting layer and a light-blocking layer, respectively, which are provided between a first substrate 604a and a second substrate 604b. Note that the first substrate 604a and the second substrate 604b are attached to each other with the use of a layer which is not illustrated.

An epoxy-based resin is preferably used for the sealant 605. It is preferable that such a material do not transmit moisture and oxygen as much as possible. As the sealing substrate 604, a glass substrate, a quartz substrate, or a plastic substrate made of fiberglass-reinforced plastics (FRP), polyvinyl fluoride (PVF), polyester, acrylic, or the like can be used.

As in this embodiment, the insulating layer 603 serving as a base film may be provided between the element substrate 610 and the semiconductor layers of the transistors. The insulating layer 603 also functions as a protective layer or a sealing film which protects the elements from external contaminants such as water, for example, those from the element substrate 610. By providing the insulating layer 603, deterioration of the light-emitting element can be suppressed; thus, the durability and lifetime of the display device can be improved.

A single layer or a stack of a nitride film and a nitride oxide film can be used as the insulating layer 603. Specifically, the insulating layer 603 can be formed using silicon oxide, silicon nitride, silicon oxynitride, aluminum oxide, aluminum nitride, aluminum oxynitride, or the like by a CVD method, a sputtering method, or the like, depending on the material. The insulating layer 603 is preferably formed using silicon nitride by a CVD method. The thickness of the insulating layer 603 may be approximately greater than or equal to 100 nm and less than or equal to 1 μm. Alternatively, an aluminum oxide film, a DLC film, a carbon film containing nitrogen, or a film containing zinc sulfide and silicon oxide (a ZnS.SiO₂ film) may be used as the insulating layer 603.

Alternatively, a thin glass substrate can be used as the insulating layer 603. For example, a glass substrate having a thickness greater than or equal to 30 μm and less than or equal to 100 μm can be used.

### <Driver Circuit>

Note that in the source side driver circuit 601, a CMOS circuit which is a combination of an n-channel transistor 623 and a p-channel transistor 624 is formed. The driver circuit may be any of a variety of circuits formed using transistors, such as a CMOS circuit, a PMOS circuit, or an NMOS circuit.

A change of the driving method from analog to digital further complicates the circuit structure of the driver circuit, causing the need for increasing integration of transistors. The transistors 623 and 624 used in the driver circuit in this embodiment are downsized transistors whose channel formation regions are formed using a single crystal semiconductor and which have high current drive capability and can operate at high speed.

Although an example in which the source side driver circuit and the gate side driver circuit are formed over the substrate is described in this embodiment, one embodiment of the present invention is not limited thereto. All or part of the source side driver circuit and the gate side driver circuit may be formed outside the substrate, not over the substrate.

### <Structure of Transistor>

In this embodiment, there is no particular limitation on the structures of the transistors 611, 612, 623, and 624 which can be used in the display device; for example, a staggered type or planar type transistor having a top-gate structure or a bottom-gate structure can be used. The transistor may have a single-gate structure in which one channel formation region is formed, a double-gate structure in which two channel formation regions are formed, or a triple-gate structure in which three channel formation regions are formed. Alternatively, the transistor may have a dual-gate structure including two gate electrode layers positioned over and below a channel region with a gate insulating layer provided therebetween.

The gate electrodes and the wiring layers (e.g., the scan line 641, the capacitor wiring 642, and the conductive layer 650) formed in the same step as the gate electrodes can be formed to have a single-layer structure or a stacked structure using any of metal materials such as molybdenum, titanium, chromium, tantalum, tungsten, aluminum, copper, neodymium, and scandium, and an alloy material containing any of these materials as a main component.

For example, as a two-layer structure of the gate electrodes, it is preferable to employ a two-layer structure in which a molybdenum layer is stacked over an aluminum layer, a two-layer structure in which a molybdenum layer is stacked over a copper layer, a two-layer structure in which a titanium nitride layer or a tantalum nitride layer is stacked over a copper layer, or a two-layer structure in which a titanium nitride layer and a molybdenum layer are stacked. As a three-layer structure, a structure in which a tungsten layer or a tungsten nitride layer, an alloy layer of aluminum and silicon or an alloy layer of aluminum and titanium, and a titanium nitride layer or a titanium layer are stacked is preferable.

A gate insulating layer can be formed to have a single-layer structure or a stacked structure using any of a silicon oxide layer, a silicon nitride layer, a silicon oxynitride layer, and a silicon nitride oxide layer by a plasma CVD method, a sputtering method, or the like. Alternatively, a silicon oxide layer formed by a CVD method using an organosilane gas can be used as the gate insulating layer. As the organosilane gas, a silicon-containing compound such as tetraethoxysilane (TEOS) (chemical formula: Si(OC₂H₅)₄), tetramethylsilane (TMS) (chemical formula: Si(CH₃)₄), tetramethylcyclotetrasiloxane (TMCTS), octamethylcyclotetrasiloxane (OMCTS), hexamethyldisilazane (HMDS), triethoxysilane (chemical formula: SiH(OC₂H₅)₃), or trisdimethylaminosilane (chemical formula: SiH(N(CH₃)₂)₃) can be used.

Examples of a material for a conductive layer serving as a source electrode or a drain electrode and wiring layers formed in the same step as the conductive layer (e.g., the signal line 643, the current supply line 644, the conductive layer 648, and the conductive layer 649) include an element selected from Al, Cr, Ta, Ti, Mo, and W; an alloy containing any of these elements as a component; and an alloy containing any of these elements in combination. Further, in the case where heat treatment is performed, the conductive layer preferably has heat resistance high enough to withstand the heat treatment. Since use of aluminum alone brings disadvantages such as low heat resistance and a tendency to corrosion, aluminum is used in combination with a conductive material having heat resistance. As the conductive material having heat resistance, which is combined with aluminum, it is possible to use an element selected from titanium (Ti), tantalum (Ta), tungsten (W), molybdenum (Mo), chromium (Cr), neodymium (Nd), and scandium (Sc); an alloy containing any of these elements as a component; an alloy containing any of these elements in combination; or a nitride containing any of these elements as a component.

An inorganic insulating film or an organic insulating film formed by a dry method or a wet method can be used for an insulating film 619 which covers the transistors 611, 612, 623, and 624. For example, a silicon nitride film, a silicon oxide film, a silicon oxynitride film, an aluminum oxide film, a tantalum oxide film, or a gallium oxide film which is formed by a CVD method, a sputtering method, or the like can be used. Alternatively, an organic material such as polyimide, acrylic, a benzocyclobutene-based resin, polyamide, or epoxy can be used. Other than such organic materials, it is possible to use a low-dielectric constant material (a low-k material), a siloxane-based resin, phosphosilicate glass (PSG), borophosphosilicate glass (BPSG), or the like.

Note that the siloxane-based resin corresponds to a resin including a Si—O—Si bond formed using a siloxane-based material as a starting material. The siloxane-based resin may include as a substituent an organic group (e.g., an alkyl group or an aryl group) or a fluoro group. In addition, the organic group may include a fluoro group. A siloxane-based resin is applied by a coating method and baked; thus, the insulating film 619 can be formed.

Note that the insulating film 619 may be formed by stacking a plurality of insulating films formed using any of the above materials. For example, the insulating film 619 may have a structure in which an organic resin film is stacked over an inorganic insulating film.

As a display method in the pixel portion, a progressive method, an interlace method, or the like can be employed. Further, color elements controlled in a pixel at the time of color display are not limited to three colors: R, G, and B (R, G, and B correspond to red, green, and blue, respectively). For example, R, G, B, and W (W corresponds to white); or R, G, B, and one or more of yellow, cyan, magenta, and the like can be used. Further, the sizes of display regions may be different between respective dots of color elements. This embodiment is not limited to the application to a display panel for color display but can also be applied to a display panel for monochrome display.

### <Substrate>

A metal plate may be provided on a bottom surface of the element substrate 610 (a surface opposite to a surface over which the light-emitting element is provided). The metal plate can be used instead of the element substrate 610 when the insulating layer 603 is provided. Although there is no particular limitation on the thickness of the metal plate, a metal plate having a thickness, for example, greater than or equal to 10 μm and less than or equal to 200 μm is preferably used, in which case a reduction in the weight of the display device can be achieved. Further, although there is no particular limitation on the material for the metal plate, a metal such as aluminum, copper, or nickel, a metal alloy such as an aluminum alloy or stainless steel, or the like can be favorably used.

The metal plate and the element substrate 610 can be bonded to each other with an adhesive layer. As the adhesive layer, a visible light curable adhesive, an ultraviolet curable adhesive, or a thermosetting adhesive can be used. As examples of materials of such adhesives, an epoxy resin, an acrylic resin, a silicone resin, and a phenol resin can be given. A moisture-absorbing substance serving as a drying agent may be contained in the adhesive layer.

According to the structure described in this embodiment, the EL layer is formed as a continuous film. This structure does not require EL layers in pixels to be separately colored using a metal mask; therefore, a decrease in yield or a complicated process caused by the use of the metal mask can be avoided. Thus, a high-definition display panel having high color reproducibility can be achieved.

The color filter layer 634 overlapping with the light-emitting element can be processed into a desired shape in a photolithography step and an etching step. Thus, a finely patterned color filter layer can be formed with high controllability, which makes it possible to obtain a high-definition display device.

Moreover, according to the structure described in this embodiment, there is no need to use a polarizing plate. Since a polarizing plate is not used, a display device having lower power consumption can be provided.

The methods, structures, and the like described in this embodiment can be combined as appropriate with any of the methods, structures, and the like described in the other embodiments.

### Embodiment 3

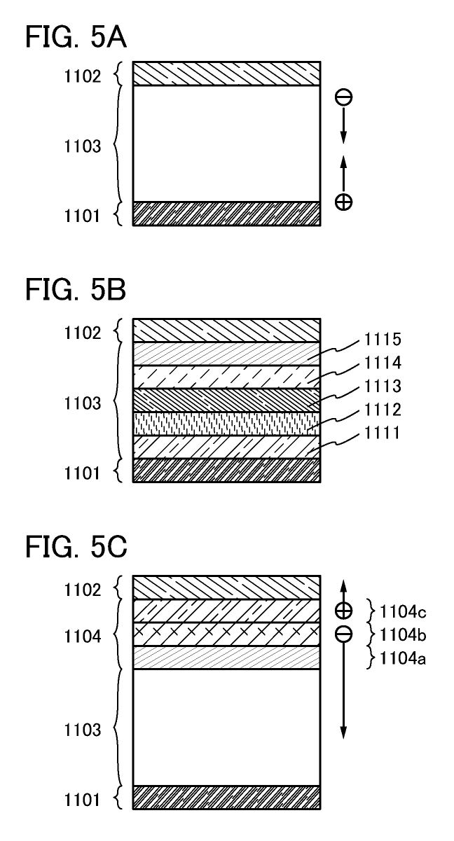

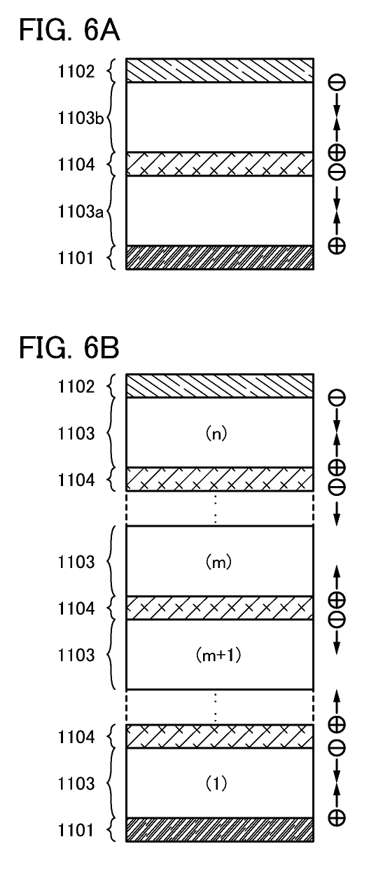

In this embodiment, an example of a light-emitting element which can be applied to a display device according to one embodiment of the present invention will be described with reference to FIGS. 5A to 5C and FIGS. 6A and 6B. Specifically, a structure of a light-emitting element emitting white light, in which a layer containing a light-emitting organic compound is interposed between a pair of electrodes, will be described.

The light-emitting element described in this embodiment includes a first electrode, a second electrode, and a layer containing a light-emitting organic compound (hereinafter referred to as EL layer) between the first electrode and the second electrode. One of the first electrode and the second electrode functions as an anode, and the other functions as a cathode. The EL layer is provided between the first electrode and the second electrode, and the structure of the EL layer may be selected as appropriate in accordance with materials of the first electrode and the second electrode. An example of the structure of the light-emitting element will be described below; needless to say, the structure of the light-emitting element is not limited to this example.

The EL layer of the light-emitting element described in this embodiment is formed so as to emit white light. For example, a structure in which a first light-emitting layer and a second light-emitting layer which emit light of different colors that are complementary colors are stacked can be employed. Alternatively, white light emission can be obtained from the light-emitting element in the following manner: the EL layer is formed by stacking a first light-emitting layer, a second light-emitting layer, and a third light-emitting layer which emit red light, green light, and blue light, respectively.

### <Structure Example 1 of Light-Emitting Element>

An example of a structure of a light-emitting element is illustrated in FIG. 5A. In the light-emitting element illustrated in FIG. 5A, an EL layer 1103 is interposed between an anode 1101 and a cathode 1102.

When voltage higher than the threshold voltage of the light-emitting element is applied between the anode 1101 and the cathode 1102, holes are injected into the EL layer 1103 from the anode 1101 side and electrons are injected into the EL layer 1103 from the cathode 1102 side. The injected electrons and holes are recombined in the EL layer 1103 and a light-emitting substance contained in the EL layer 1103 emits light.

The EL layer 1103 may include at least a light-emitting layer containing a light-emitting substance, and may have a structure in which the light-emitting layer and a layer other than the light-emitting layer are stacked. Examples of the layer other than the light-emitting layer include a layer containing a substance having a high hole-injection property, a layer containing a substance having a high hole-transport property, a layer containing a substance having a poor hole-transport property (a substance which blocks holes), a layer containing a substance having a high electron-transport property, a layer containing a substance having a high electron-injection property, and a layer containing a substance having a bipolar property (a substance having high electron-and-hole-transport properties).

An example of a specific structure of the EL layer 1103 is illustrated in FIG. 5B. The EL layer 1103 illustrated in FIG. 5B has a structure in which a hole-injection layer 1111, a hole-transport layer 1112, a light-emitting layer 1113, an electron-transport layer 1114, and an electron-injection layer 1115 are stacked in this order from the anode 1101 side.

### <Structure Example 2 of Light-Emitting Element>

Another example of a structure of a light-emitting element is illustrated in FIG. 5C. In the light-emitting element illustrated in FIG. 5C, the EL layer 1103 is interposed between the anode 1101 and the cathode 1102. Further, an intermediate layer 1104 is provided between the cathode 1102 and the EL layer 1103. Note that a structure similar to that in Structure Example 1 of Light-Emitting Element can be applied to the EL layer 1103 in Structure Example 2 of Light-Emitting Element, and for the details, the description in Structure Example 1 of Light-Emitting Element can be referred to.

The intermediate layer 1104 may be formed to include at least a charge generation region, and may have a structure in which the charge generation region and a layer other than the charge generation region are stacked. For example, a structure can be employed in which a first charge generation region 1104c, an electron-relay layer 1104b, and an electron-injection buffer 1104a are stacked in this order from the cathode 1102 side.

The behaviors of electrons and holes in the intermediate layer 1104 will be described. When voltage higher than the threshold voltage of the light-emitting element is applied between the anode 1101 and the cathode 1102, holes and electrons are generated in the first charge generation region 1104c, and the holes move into the cathode 1102 and the electrons move into the electron-relay layer 1104b. The electron-relay layer 1104b has a high electron-transport property and immediately transfers the electrons generated in the first charge generation region 1104c to the electron-injection buffer 1104a. The electron-injection buffer 1104a can reduce a barrier to electron injection into the EL layer 1103, so that the efficiency of the electron injection into the EL layer 1103 can be improved. Thus, the electrons generated in the first charge generation region 1104c are injected into the LUMO level of the EL layer 1103 through the electron-relay layer 1104b and the electron-injection buffer 1104a.

In addition, the electron-relay layer 1104b can prevent interaction in which, for example, a substance contained in the first charge generation region 1104c and a substance contained in the electron-injection buffer 1104a react with each other at an interface therebetween to impair the functions of the first charge generation region 1104c and the electron-injection buffer 1104a.

The range of choices of materials that can be used for the cathode in Structure Example 2 of Light-Emitting Element is wider than that of materials that can be used for the cathode in Structure Example 1. This is because the cathode in Structure Example 2 may just receive holes generated in the intermediate layer and a material having a relatively high work function can be used.

### <Structure Example 3 of Light-Emitting Element>

Another example of a structure of a light-emitting element is illustrated in FIG. 6A. In the light-emitting element illustrated in FIG. 6A, two EL layers are provided between the anode 1101 and the cathode 1102. Further, the intermediate layer 1104 is provided between an EL layer 1103a and an EL layer 1103b.

Note that the number of EL layers provided between the anode and the cathode is not limited to two. The light-emitting element illustrated in FIG. 6B has a structure in which a plurality of EL layers 1103 is stacked (a so-called tandem structure). Note that in the case where n (n is a natural number greater than or equal to 2) EL layers 1103 are provided between the anode and the cathode, for example, the intermediate layer 1104 is provided between an m-th (m is a natural number greater than or equal to 1 and less than or equal to n−1) EL layer and an (m+1)-th EL layer.

Note that a structure similar to that in Structure Example 1 of Light-Emitting Element can be applied to the EL layer 1103 in Structure Example 3 of Light-Emitting Element; a structure similar to that in Structure Example 2 of Light-Emitting Element can be applied to the intermediate layer 1104 in Structure Example 3 of Light-Emitting Element. Thus, for the details, the description in Structure Example 1 of Light-Emitting Element or Structure Example 2 of Light-Emitting Element can be referred to.

The behaviors of electrons and holes in the intermediate layer 1104 provided between the EL layers will be described. When voltage higher than the threshold voltage of the light-emitting element is applied between the anode 1101 and the cathode 1102, holes and electrons are generated in the intermediate layer 1104, and the holes move into the EL layer provided on the cathode 1102 side and the electrons move into the EL layer provided on the anode 1101 side. The holes injected into the EL layer provided on the cathode side are recombined with electrons injected from the cathode side, so that the light-emitting substance contained in the EL layer emits light. The electrons injected into the EL layer provided on the anode side are recombined with holes injected from the anode side, so that the light-emitting substance contained in the EL layer emits light. Thus, the holes and electrons generated in the intermediate layer 1104 cause light emission in the respective EL layers.

Note that the EL layers can be provided in contact with each other when these EL layers allow the same structure as the intermediate layer to be formed therebetween. Specifically, when a charge generation region is formed on one surface of the EL layer, the charge generation region functions as a first charge generation region of an intermediate layer; thus, the EL layers can be provided in contact with each other.

Structure Examples 1 to 3 of Light-Emitting Element can be implemented in combination. For example, an intermediate layer may be provided between the cathode and the EL layer in Structure Example 3 of Light-Emitting Element.

### <Structure for White Light Emission>

In a structure in which two EL layers are stacked, when the color of light obtained from a first EL layer and the color of light obtained from a second EL layer are complementary to each other, white light can be extracted to the outside. White light can also be obtained in a structure in which each of the first EL layer and the second EL layer includes a plurality of light-emitting layers emitting light of complementary colors.

Examples of the complementary colors are “blue and yellow” and “blue-green and red”. A substance which emits light of blue, yellow, blue-green, red, or the like may be selected as appropriate from, for example, light-emitting substances such as fluorescent compounds and phosphorescent compounds.

An example of a structure of a light-emitting element in which a plurality of EL layers is stacked will be described below. First, an example of a structure in which each of the first EL layer and the second EL layer includes a plurality of light-emitting layers which emit light of complementary colors will be described. With this structure, white light can be obtained.

### Structure Example 3-1

For example, the first EL layer includes a first light-emitting layer which emits light having an emission spectrum peak in the wavelength range of blue to blue-green, and a second light-emitting layer which emits light having an emission spectrum peak in the wavelength range of yellow to orange. The second EL layer includes a third light-emitting layer which emits light having an emission spectrum peak in the wavelength range of blue-green to green, and a fourth light-emitting layer which emits light having an emission spectrum peak in the wavelength range of orange to red.

In that case, light emitted from the first EL layer is a combination of light emitted from the first light-emitting layer and light emitted from the second light-emitting layer, and thus light having emission spectrum peaks both in the wavelength range of blue to blue-green and in the wavelength range of yellow to orange is emitted. That is, the first EL layer emits light of two-wavelength type white or a two-wavelength type color close to white.

Further, light emitted from the second EL layer is a combination of light emitted from the third light-emitting layer and light emitted from the fourth light-emitting layer, and thus light having emission spectrum peaks both in the wavelength range of blue-green to green and in the wavelength range of orange to red is emitted. That is, the second EL layer emits light of two-wavelength type white or a two-wavelength type color close to white, which is different from that of the first EL layer.

Accordingly, by combining the light emission from the first EL layer and the light emission from the second EL layer, a light-emitting element emitting white light which covers the wavelength range of blue to blue-green, the wavelength range of blue-green to green, the wavelength range of yellow to orange, and the wavelength range of orange to red can be obtained.

Further, the wavelength range of yellow to orange (greater than or equal to 560 nm and less than 580 nm) is a wavelength range of high luminosity; thus, application of an EL layer which includes a light-emitting layer having an emission spectrum peak in the wavelength range of yellow to orange is effective. For example, a structure can be employed in which a first EL layer including a light-emitting layer having an emission spectrum peak in the blue wavelength range, a second EL layer including a light-emitting layer having an emission spectrum peak in the yellow wavelength range, and a third EL layer including a light-emitting layer having an emission spectrum peak in the red wavelength range are stacked.

Further, two or more EL layers exhibiting yellow to orange may be stacked. The power efficiency of the light-emitting element can be further improved by stacking two or more EL layers exhibiting yellow to orange.

### Structure Example 3-2

For example, a light-emitting element emitting white light can be formed by stacking three EL layers. A structure may be employed in which a light-emitting layer having an emission spectrum peak in the blue wavelength range (greater than or equal to 400 nm and less than 480 nm) is provided in the first EL layer and light-emitting layers each having an emission spectrum peak in the wavelength range of yellow to orange are provided in the second EL layer and the third EL layer. Note that the wavelengths of the emission spectrum peaks of light emitted from the second EL layer and the third EL layer may be the same or different from each other.

When the EL layers are stacked, the power efficiency of the light-emitting element can be improved; however, there occurs a problem in that the manufacturing process becomes complicated. Thus, the structure in which three EL layers are stacked is preferable because the power efficiency is higher than that in the case of a structure of two EL layers and the manufacturing process is simpler than that in the case of a structure of four or more EL layers.

### <Material for Light-Emitting Element>

Next, specific materials that can be used for the light-emitting element having the above structure will be described. Materials for the anode, the cathode, the EL layer, the first charge generation region, the electron-relay layer, and the electron-injection buffer will be described in this order.

### <Material for Anode>

The anode 1101 is preferably formed using a metal, an alloy, an electrically conductive compound, a mixture of any of these materials, or the like which has a high work function (specifically, a work function higher than or equal to 4.0 eV is preferable). Specifically, for example, indium tin oxide (ITO), indium tin oxide containing silicon or silicon oxide, indium zinc oxide, and indium oxide containing tungsten oxide and zinc oxide are given.

Films of these conductive metal oxides are usually formed by a sputtering method, but may also be formed by application of a sol-gel method or the like. For example, an indium zinc oxide film can be formed by a sputtering method using a target in which zinc oxide is added to indium oxide at a proportion higher than or equal to 1 wt % and lower than or equal to 20 wt %. An indium oxide film containing tungsten oxide and zinc oxide can be formed by a sputtering method using a target which contains tungsten oxide and zinc oxide at a proportion higher than or equal to 0.5 wt % and lower than or equal to 5 wt % and a proportion higher than or equal to 0.1 wt % and lower than or equal to 1 wt %, respectively, with respect to indium oxide.

Besides, as examples of a material for the anode 1101, the following can be given: gold (Au), platinum (Pt), nickel (Ni), tungsten (W), chromium (Cr), molybdenum (Mo), iron (Fe), cobalt (Co), copper (Cu), palladium (Pd), titanium (Ti), a nitride of a metal material (e.g., titanium nitride), molybdenum oxide, vanadium oxide, ruthenium oxide, tungsten oxide, manganese oxide, and titanium oxide. Alternatively, a conductive polymer such as poly(3,4-ethylenedioxythiophene)/poly(styrenesulfonic acid) (PEDOT/PSS) or polyaniline/poly(styrenesulfonic acid) (PAni/PSS) may be used.

Note that in the case where a second charge generation region is provided in contact with the anode 1101, a variety of conductive materials can be used for the anode 1101 regardless of their work functions. Specifically, besides a material which has a high work function, a material which has a low work function can be used for the anode 1101. A material for forming the second charge generation region will be described later together with a material for forming the first charge generation region.

### <Material for Cathode>

In the case where the first charge generation region 1104c is provided between the cathode 1102 and the EL layer 1103 so as to be in contact with the cathode 1102, a variety of conductive materials can be used for the cathode 1102 regardless of their work functions.

Note that at least one of the cathode 1102 and the anode 1101 is formed using a conductive film that transmits visible light. As examples of a material for the conductive film that transmits visible light, indium oxide containing tungsten oxide, indium zinc oxide containing tungsten oxide, indium oxide containing titanium oxide, indium tin oxide containing titanium oxide, indium tin oxide (hereinafter referred to as ITO), indium zinc oxide, and indium tin oxide to which silicon oxide is added can be given. Further, a thin metal film having a thickness small enough to transmit light (preferably, approximately greater than or equal to 5 nm and less than or equal to 30 nm) can be used. In this case, the thin metal film serves as a semi-transmissive and semi-reflective electrode.

### <Material for EL Layer>

Specific examples of materials for the layers included in the EL layer 1103 described above will be shown below.

The hole-injection layer is a layer containing a substance having a high hole-injection property. As the substance having a high hole-injection property, for example, molybdenum oxide, vanadium oxide, ruthenium oxide, tungsten oxide, or manganese oxide can be used. In addition, it is possible to use a phthalocyanine-based compound such as phthalocyanine (abbreviation: H₂Pc) or copper phthalocyanine (abbreviation: CuPc), a high molecule such as poly(3,4-ethylenedioxythiophene)/poly(styrenesulfonic acid) (PEDOT/PSS), or the like to form the hole-injection layer.

Note that the hole-injection layer may be formed using the second charge generation region. When the second charge generation region is used for the hole-injection layer, a variety of conductive materials can be used for the anode 1101 regardless of their work functions as described above. A material for forming the second charge generation region will be described later together with a material for forming the first charge generation region.

The hole-transport layer is a layer containing a substance having a high hole-transport property. The hole-transport layer is not limited to a single layer, but may be a stack of two or more layers each containing a substance having a high hole-transport property. The hole-transport layer may contain any substance having a property of transporting more holes than electrons, and preferably contains a substance having a hole mobility higher than or equal to 10⁻⁶ cm²/Vs because the driving voltage of the light-emitting element can be reduced.

The light-emitting layer is a layer containing a light-emitting substance. The light-emitting layer is not limited to a single layer, but may be a stack of two or more layers each containing a light-emitting substance. As the light-emitting substance, a fluorescent compound or a phosphorescent compound can be used. A phosphorescent compound is preferably used as the light-emitting substance because the emission efficiency of the light-emitting element can be increased.

Note that the light-emitting substance is preferably dispersed in a host material.

The electron-transport layer is a layer containing a substance having a high electron-transport property. The electron-transport layer is not limited to a single layer, but may be a stack of two or more layers each containing a substance having a high electron-transport property. The electron-transport layer may contain any substance having a property of transporting more electrons than holes, and preferably contains a substance having an electron mobility higher than or equal to 10⁻⁶ cm²/Vs because the driving voltage of the light-emitting element can be reduced.

The electron-injection layer is a layer containing a substance having a high electron-injection property. The electron-injection layer is not limited to a single layer, but may be a stack of two or more layers each containing a substance having a high electron-injection property. The electron-injection layer is preferably provided because the efficiency of electron injection from the cathode 1102 can be increased and the driving voltage of the light-emitting element can be reduced.

As a method of forming the EL layer 1103 by combining these layers as appropriate, any of a variety of methods (e.g., a dry method and a wet method) can be selected as appropriate. For example, a vacuum evaporation method, an inkjet method, or a spin coating method may be selected in accordance with a material to be used. Note that a different formation method may be employed for each layer.

### <Material for Charge Generation Region>

The first charge generation region 1104c and the second charge generation region are each a region containing a substance having a high hole-transport property and an acceptor substance. The charge generation region is not limited to the structure in which one film contains the substance having a high hole-transport property and the acceptor substance, and may be a stack of a layer containing the substance having a high hole-transport property and a layer containing the acceptor substance. Note that in the case of a stacked structure in which the first charge generation region is provided on the cathode side, the layer containing the substance having a high hole-transport property is in contact with the cathode 1102, and in the case of a stacked structure in which the second charge generation region is provided on the anode side, the layer containing the acceptor substance is in contact with the anode 1101.

Note that the acceptor substance is preferably added to the charge generation region so that the mass ratio of the acceptor substance to the substance having a high hole-transport property is greater than or equal to 0.1:1 and less than or equal to 4.0:1.

As examples of the acceptor substance used for the charge generation region, a transition metal oxide and an oxide of a metal belonging to any of Groups 4 to 8 of the periodic table can be given. Specifically, molybdenum oxide is particularly preferable. Note that molybdenum oxide has a low hygroscopic property.

As the substance having a high hole-transport property used for the charge generation region, any of a variety of organic compounds such as an aromatic amine compound, a carbazole derivative, an aromatic hydrocarbon, and a high molecular compound (such as an oligomer, a dendrimer, or a polymer) can be used. Specifically, a substance having a hole mobility higher than or equal to 10⁻⁶ cm²/Vs is preferably used.

### <Material for Electron-Relay Layer>

The electron-relay layer 1104b is a layer that can immediately receive electrons drawn out by the acceptor substance in the first charge generation region 1104c. Therefore, the electron-relay layer 1104b is a layer containing a substance having a high electron-transport property, and the LUMO level thereof is positioned between the acceptor level of the acceptor substance in the first charge generation region 1104c and the LUMO level of the EL layer 1103. Specifically, the LUMO level of the electron-relay layer 1104b is preferably approximately higher than or equal to −5.0 eV and lower than or equal to −3.0 eV.

As examples of the substance used for the electron-relay layer 1104b, a perylene derivative and a nitrogen-containing condensed aromatic compound can be given. Note that a nitrogen-containing condensed aromatic compound is preferably used for the electron-relay layer 1104b because of its stability. Among nitrogen-containing condensed aromatic compounds, a compound having an electron-withdrawing group such as a cyano group or a fluoro group is preferably used because such a compound further facilitates reception of electrons in the electron-relay layer 1104b.

### <Material for Electron-Injection Buffer>

The electron-injection buffer 1104a is a layer that facilitates electron injection from the first charge generation region 1104c into the EL layer 1103. The provision of the electron-injection buffer 1104a between the first charge generation region 1104c and the EL layer 1103 makes it possible to reduce the injection barrier therebetween.

The light-emitting element described in this embodiment can be manufactured by combination of the above-described materials.

This embodiment can be combined with any of the other embodiments in this specification, as appropriate.

### Embodiment 4

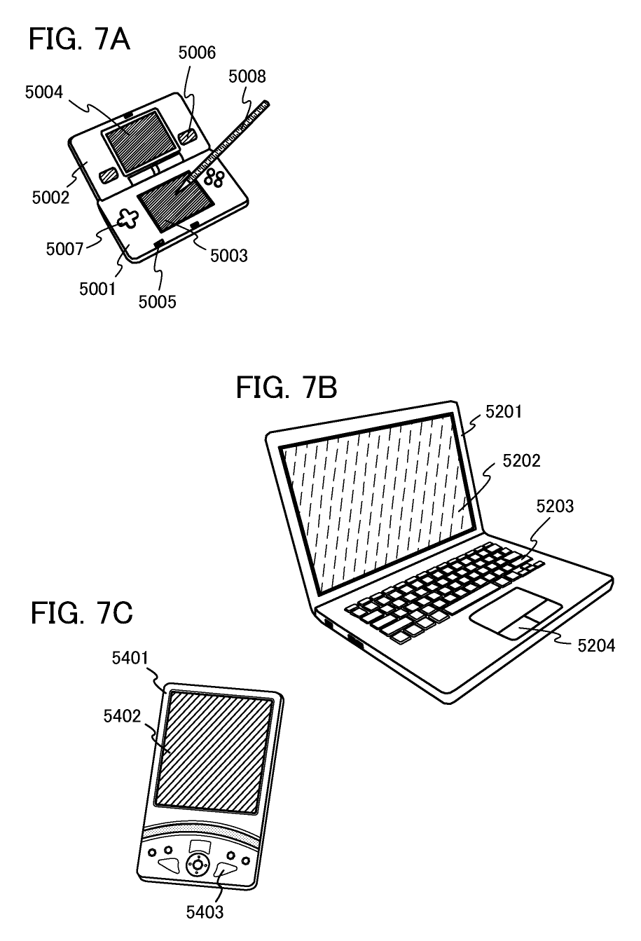

A display device according to one embodiment of the present invention can be applied to laptop computers, and image reproducing devices provided with recording media (typically devices which reproduce the content of recording media such as digital versatile discs (DVDs) and have displays for displaying the reproduced image). Other examples of electronic appliances that can include the display device according to one embodiment of the present invention are mobile phones, portable game consoles, personal digital assistants, e-book readers, cameras such as video cameras and digital still cameras, goggle-type displays (head mounted displays), navigation systems, audio reproducing devices (such as car audio systems and digital audio players), copiers, facsimiles, printers, multifunction printers, automated teller machines (ATM), and vending machines. In this embodiment, specific examples of such electronic appliances will be described with reference to FIGS. 7A to 7C.

FIG. 7A illustrates a portable game console including a housing 5001, a housing 5002, a display portion 5003, a display portion 5004, a microphone 5005, a speaker 5006, an operation key 5007, a stylus 5008, and the like. The display device according to one embodiment of the present invention can be used for the display portion 5003 or the display portion 5004. By using the display device according to one embodiment of the present invention for the display portion 5003 or the display portion 5004, it is possible to provide a highly useful portable game console capable of displaying 3D images. Note that although the portable game console illustrated in FIG. 7A has the two display portions 5003 and 5004, the number of display portions included in the portable game console is not limited to this.

FIG. 7B illustrates a laptop computer including a housing 5201, a display portion 5202, a keyboard 5203, a pointing device 5204, and the like. The display device according to one embodiment of the present invention can be used for the display portion 5202. By using the display device according to one embodiment of the present invention for the display portion 5202, it is possible to provide a highly useful laptop computer capable of displaying 3D images.

FIG. 7C illustrates a personal digital assistant including a housing 5401, a display portion 5402, an operation key 5403, and the like. The display device according to one embodiment of the present invention can be used for the display portion 5402. By using the display device according to one embodiment of the present invention for the display portion 5402, it is possible to provide a highly useful personal digital assistant capable of displaying 3D images.

This embodiment can be implemented in appropriate combination with the structures described in the other embodiments.

This application is based on Japanese Patent Application serial no. 2011-097819 filed with the Japan Patent Office on Apr. 26, 2011, the entire contents of which are hereby incorporated by reference.

What is claimed is:

1. A display device comprising:
a display panel including a plurality of pairs of pixels, each pair of pixel comprising a pixel for a right eye and a pixel for a left eye; and
a parallax barrier panel including a plurality of light-blocking parallax barriers and light-transmitting regions between the parallax barriers,
wherein the parallax barriers each include a light-blocking layer interposed between one surface of a first substrate and a second substrate,
wherein the light-transmitting regions each include a light-transmitting layer interposed between the one surface of the first substrate and the second substrate,
wherein another surface of the first substrate in the parallax barrier panel faces a display surface of the display panel, the one surface being closer to the parallax barriers than the other surface,
wherein the parallax barriers are provided above and at a distance from a plane comprising top surfaces of the pairs of pixel greater than or equal to a thickness of the first substrate and less than or equal to 0.7 mm, and
wherein a refraction index of the light-transmitting layer is different from a refraction index of the first substrate or a refraction index of the second substrate.

2. A display device comprising:
a display panel including a plurality of pairs of pixels, each pair of pixel comprising a pixel for a right eye and a pixel for a left eye; and
a parallax barrier panel including a plurality of light-blocking parallax barriers and light-transmitting regions between the parallax barriers,
wherein the pairs of pixels comprise light-emitting elements including a plurality of reflective electrodes over an element substrate, a semi-transmissive and semi-reflective electrode overlapping with the reflective electrodes, and a layer containing a light-emitting compound between the reflective electrodes and the semi-transmissive and semi-reflective electrode,
wherein the parallax barriers each include a light-blocking layer interposed between one surface of a first substrate and a second substrate,
wherein the light-transmitting regions each include a light-transmitting layer interposed between the one surface of the first substrate and the second substrate,
wherein the light-emitting elements are sealed between the element substrate and the other surface of the first substrate in the parallax barrier panel, with a sealant surrounding the plurality of light-emitting elements,
wherein another surface of the first substrate in the parallax barrier panel faces a display surface of the display panel, the one surface being closer to the parallax barriers than the other surface,
wherein the parallax barriers are provided above and at a distance from a plane comprising top surfaces of the pairs of pixel greater than or equal to a thickness of the first substrate and less than or equal to 0.7 mm, and
wherein a refraction index of the light-transmitting layer is different from a refraction index of the first substrate or a refraction index of the second substrate.

3. A display device comprising:
a display panel including a plurality of pairs of pixels, each pair of pixel comprising a pixel for a right eye and a pixel for a left eye; and
a parallax barrier panel including a plurality of light-blocking parallax barriers and light-transmitting regions between the parallax barriers,
wherein each pixel comprises a liquid crystal display element,
wherein the parallax barriers each include a light-blocking layer interposed between one surface of a first substrate and a second substrate,
wherein the light-transmitting regions each include a light-transmitting layer interposed between the one surface of the first substrate and the second substrate,
wherein another surface of the first substrate in the parallax barrier panel faces a display surface of the display panel, the one surface being closer to the parallax barriers than the other surface,
wherein the parallax barriers are provided above and at a distance from a plane comprising top surfaces of the pairs of pixel greater than or equal to a thickness of the first substrate and less than or equal to 0.7 mm, and
wherein a refraction index of the light-transmitting layer is different from a refraction index of the first substrate or a refraction index of the second substrate.

4. The display device according to claim 1,
wherein the refraction index of the first substrate and the refraction index of the second substrate are each higher than or equal to 1.3 and lower than or equal to 1.6, and
wherein the refraction index of the light-transmitting layer is higher than or equal to 1.0 and lower than or equal to 1.1.

5. The display device according to claim 2,
wherein the refraction index of the first substrate and the refraction index of the second substrate are each higher than or equal to 1.3 and lower than or equal to 1.6, and
wherein the refraction index of the light-transmitting layer is higher than or equal to 1.0 and lower than or equal to 1.1.

6. The display device according to claim 3,
wherein the refraction index of the first substrate and the refraction index of the second substrate are each higher than or equal to 1.3 and lower than or equal to 1.6, and
wherein the refraction index of the light-transmitting layer is higher than or equal to 1.0 and lower than or equal to 1.1.

7. The display device according to claim 1,
wherein a width of the light-transmitting layer is greater than or equal to 32 μm and less than or equal to 72 μm.

8. The display device according to claim 2,
wherein a width of the light-transmitting layer is greater than or equal to 32 μm and less than or equal to 72 μm.

9. The display device according to claim 3,
wherein a width of the light-transmitting layer is greater than or equal to 32 μm and less than or equal to 72 μm.

10. The display device according to claim 1,
wherein a distance from a center of the pixel for the right eye to a center of the pixel for the left eye is greater than or equal to 36.3 μm and less than or equal to 72.6 μm.

11. The display device according to claim 2,
wherein a distance from a center of the pixel for the right eye to a center of the pixel for the left eye is greater than or equal to 36.3 μm and less than or equal to 72.6 μm.

12. The display device according to claim 3,
wherein a distance from a center of the pixel for the right eye to a center of the pixel for the left eye is greater than or equal to 36.3 μm and less than or equal to 72.6 μm.

13. The display device according to claim 1,
wherein a thickness of the first substrate is greater than or equal to 0.1 mm and less than or equal to 0.5 mm.

14. The display device according to claim 2,
wherein a thickness of the first substrate is greater than or equal to 0.1 mm and less than or equal to 0.5 mm.

15. The display device according to claim 3,
wherein a thickness of the first substrate is greater than or equal to 0.1 mm and less than or equal to 0.5 mm.

16. A display panel including the display device according to claim 1.

17. A display panel including the display device according to claim 2.

18. A display panel including the display device according to claim 3.
